(19) United States
(12) Patent Application Publication
(10) Pub. No.: US 2024/0348942 A1
(43) Pub. Date: Oct. 17, 2024

(54) METHOD AND APPARATUS FOR ENSURING SURGICAL INSTRUMENT INTEGRITY

(71) Applicant: Bedrock Surgical, Inc, Palo Alto, CA (US)

(72) Inventors: David Stoker, Belmont, CA (US); Jan Van Der Laan, Oakland, CA (US); Erik Matlin, San Jose, CA (US)

(73) Assignee: Bedrock Surgical, Inc, Palo Alto, CA (US)

(21) Appl. No.: 18/682,916

(22) PCT Filed: Aug. 11, 2022
(86) PCT No.: PCT/US22/40131

§ 371 Date: Feb. 11, 2024

Related U.S. Application Data
(60) Provisional application No. 63/232,085, filed on Aug. 11, 2021.

(51) Int. Cl. H04N 23/957; G06T 7/00

(52) U.S. Cl. CPC H04N 23/957; G06T 7/0014; G06T 2207/20081; G06T 2207/30004

(57) ABSTRACT

The system and methods described herein are directed to a system for detecting deficiencies in surgical instruments that would justify removing them from service. By placing an engineered optical surface with spatially varying optical transmission properties in front of the objective lens of a plenoptic camera, the plenoptic camera can be used to digitally compute a multitude of different optical properties using a single camera and sensor.

### CROSS-REFERENCES

This application claims the benefit of U.S. Provisional Application No. 63/232,085, filed Aug. 11, 2021.

### BACKGROUND

This technology relates generally to imaging of surgical instruments and, more particularly, to methods of detection of abnormalities when the surgical instruments are processed via a consistent repeatable process. U.S. Provisional Application No. 63/232,085, filed Aug. 11, 2021, the entire disclosure of which, except for any definitions, disclaimers, disavowals, and inconsistencies, is incorporated herein by reference.

### SUMMARY

In sterile processing departments, it is of utmost importance that instruments that are being sent to operating rooms are sterile and free of hidden defects. Unfortunately, human visual inspection often misses both physical contamination and instrument damage.

In developing a mechanism to detect issues before they are placed into service it has become clear that there is a need for a repeatable process that allows detection with a high confidence level.

There exists a need for process that consistently catches devices that need to be removed from service.

When deciding about design choices with respect to a system in accordance with the present invention, simplicity is a preferable design choice that is disclosed herein.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of embodiments in accordance with the present invention are apparent in the following detailed description and claims.

### DESCRIPTION OF THE FIGURES

The patent or application file contains at least one image executed in color. Copies of this patent or patent application publication with color drawing(s) will be provided by the Office upon request and payment of the necessary fee.

Various example embodiments can be more completely understood in consideration of the following detailed description in connection with the accompanying drawings, in which:

FIG. 1 is one configuration for detecting foreign material on an instrument.

FIG. 2 is a second configuration for detecting foreign material on an instrument.

### DETAILED DESCRIPTION

This technology relates generally to surgical instruments and, more particularly, to apparatus' for and methods of assessing if surgical instruments have been damaged.

This disclosure describes inventive concepts with reference to specific examples. However, the intent is to cover all modifications, equivalents, and alternatives of the inventive concepts that are consistent with this disclosure. It will be apparent, however, to one of ordinary skill in the art that the present approach can be practiced without these specific details. Thus, the specific details set forth are merely exemplary, and is not intended to limit what is presently disclosed. The features implemented in one embodiment may be implemented in another embodiment where logically possible. The specific details can be varied from and still be contemplated to be within the spirit and scope of what is being disclosed.

This disclosure describes inventive concepts with reference to specific examples. However, the intent is to cover all modifications, equivalents, and alternatives of the inventive concepts that are consistent with this disclosure. It will be apparent, however, to one of ordinary skill in the art that the present approach can be practiced without these specific details. Thus, the specific details set forth are merely exemplary, and is not intended to limit what is presently disclosed. The features implemented in one embodiment may be implemented in another embodiment where logically possible. The specific details can be varied from and still be contemplated to be within the spirit and scope of what is being disclosed.

Surgical procedures carry an inherent risk to the patient. Not only is the patient depending on the skills of the surgical team, but the patient is also banking on the fact that all the instruments being used in his/her surgery meet some quality assurance, are free from defects, and sterile. Unfortunately, over time, surgical instruments can become dull or even damaged.

Furthermore, in some instances, there is no efficient way to ensure that reusable surgical instruments are in fact clean and sterile. Described herein are systems and methods that address instrument sharpness and defects as well as whether instruments are sterile and free of any bioburden (that is not easily detectable with the human eye).

### Detecting Bioburden in Sterile Processing of Surgical Instruments.

The method disclosed creates a unique, machine-readable feature that indicates the presence of bioburden on surgical tools. Moreover, this feature is spectrally unique compared to potential interferent signatures, rendering a superior and more accurate bioburden detection

method. The unique signature of bioburden created with this method then enables automated methods of detecting bioburden in surgical tools. Bioburden is defined as . . . .

Currently, in some practices, a non-specific ultraviolet excited fluorescence is used. The signal observed for this non-specific method can create false alarms from intrinsic fluorescence of detergents.

The system and methods disclosed address the problem of detecting bioburden by modifying several steps in the sterilization process. First, the system includes engineered detergents containing molecules that bind specifically to one or more bio-burden targets such as albumin (protein) but may also be extended to whole cells or bacteria. Also, the antibody and antigen labels interact with specific molecular groups in proteins such as carboxyl groups. These antigens are bonded to fluorescent taggant molecules that have unique spectral detection lines far from the intrinsic ultraviolet-excited fluorescent of detergents. Further, the method step also includes a step for detecting the bioburden by examining the surface of the tool for fluorescent signatures created by the binding agents using a unique 3D surface scanning apparatus.

As alluded to earlier, plasma protein binding can be an effective means of indicating bioburden. There are several peptides that can be used as protein binding agents and these peptides can be chemically modified to incorporate optical tags, using techniques similar to protein tagging. Prior work has taught us to identify a series of peptides having the core sequence DICLPRWGCLW that specifically bind serum albumin from multiple species with high affinity. With tagging, this peptide can be incorporated into a detergent and used to enhance the ability for both people and machines to detect bioburden on surgical tools.

Peptides can be modified through their carboxyl groups to contain fluorescent tags. Labeling peptides with fluorescent dyes or other labels provide powerful tools for the investigation of biological relevant interactions but can also be used as a detection method.

Fluorescence energy transfer (FRET) between a donor and an acceptor label can be applied for such investigations. FRET can be determined by several different methods, e.g., quenching and other intensity measurements, donor or acceptor depletion kinetics, and fluorescence lifetime or emission anisotropy measurements.

Labeled peptides can be prepared by either modifying isolated peptides or by incorporating the label during solid-phase synthesis. One of the following strategies may be used to label the peptide with a dye molecule.

Labeling during synthesis of peptide. Dyes that are not damaged by unblocking procedures are incorporated onto the amino terminus of the peptide chain.

Synthetic peptides can be covalently modified on specific residues and labels incorporated following synthesis.

Synthetic peptides may be covalently labeled by amine- or thiol-reactive protein labels.

Fluorophores can be conjugated to the N-terminus of a resin-bound peptide before other protecting groups are removed and the labeled peptide is released from the resin. Amine-reactive fluorophores are used in about 5-fold molar excess relative to the amines of the immobilized peptide. Reactive fluorescein, sulforhodamine B, tetramethylrhodamine, coumarin, eosin, Dabcyl, Dabsyl, or biotin labels, as well as several new Atto labels, should be stable enough to resist the harsh deprotection conditions. Dabcyl has been frequently used as quencher. Another possibility is the use of fluorescence or chromophore labeled amino acids to incorporate labels at specific sites of peptides. Labeling can also be achieved indirectly by using a biotinylated amino acid. If, for example, Fmoc-Lys (biotinyl)-OH, no. 73749 is used in peptide synthesis, the biotin group allows specific binding of streptavidin or avidin-conjugate to that site. A variety of fluorophores are available as (strept) avidin conjugates.

Following the routine synthesis procedure, peptides can also be labeled by practically all labels used for protein labeling. This means mainly amine reactive labels, or thiol reactive labels, if a cysteine has been used for the peptide. Whereas the common standard procedures for protein labeling are based on aqueous solutions of target proteins, labeling peptides in organic solvents like DMSO or DMF requires specific modifications. Use of triethylamine can be added to ensure that the target amino groups of the peptide are deprotonated, which is required for the labeling procedure.

Once the peptide is suitably labeled, it can be incorporated in solid form into a detergent. During use of the detergent, a small amount of organic solvent is added to promote binding of the peptide to any available surface albumin molecules.

Finally, the instrument is introduced into a sensor (it could be a standalone box or module along an assembly line) that performs fluorescence detection of the labeled peptides. The measurement, itself is performed by passing an instrument through a multidirectional illumination source, while simultaneously measuring the fluorescence from all surfaces of the surgical device.

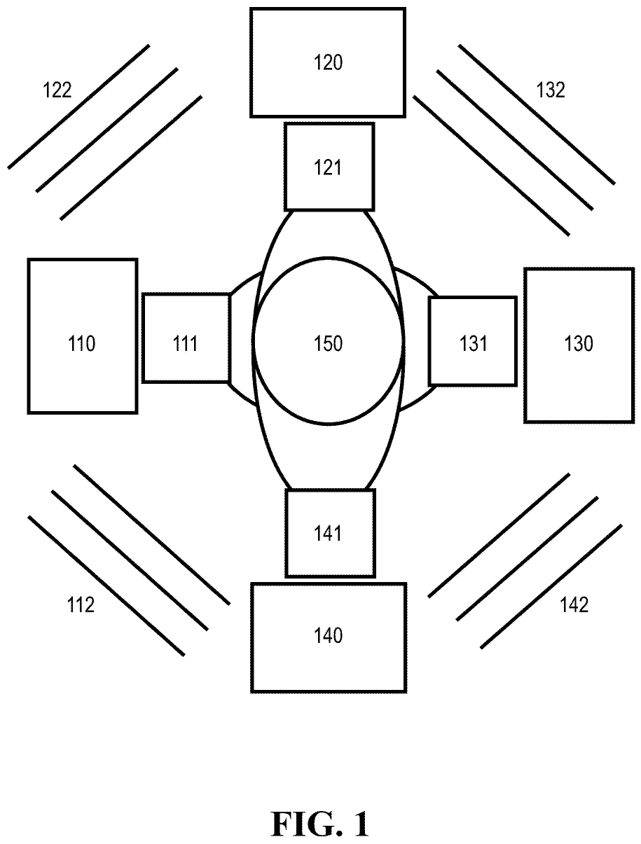

In one configuration (FIG. 1), the detection is performed using intense, wide-field illumination and several visible cameras equipped with narrow bandpass filters for only the fluorescence of the labeled peptides.

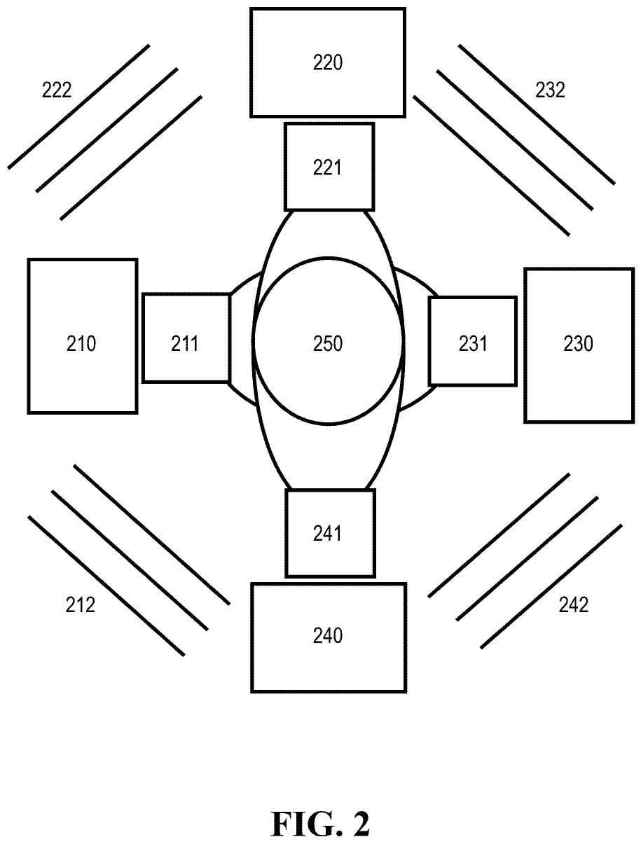

In a separate configuration (FIG. 2), the detection is performed using a rastered line scan and several photon counting modules placed around the tool. In this configuration, the user is free to ‘dip’ or traverse the tool in any direction while observing signals in real time.

The primary benefits of this invention include: 1) improved detection accuracy; 2) greater information utilization and human-machine synergy in the sterile processing environment; 3) increased data analytics for detecting and reporting operating room contamination (bacteria, CDIF, etc.).

### Automatically Detecting Cutting Edge Sharpness and Degradation of Surgical Instruments.

Also described herein a non-contact, versatile optical scattering tools for measuring various flaws in surgical tools including cutting sharpness, pitting, cracking, and corrosion. The traditional method for measuring edge sharpness requires a person to pick up a cutting tool and use it to perform a test cut on a tissue surrogate (usually a piece of latex). This process is slow and tedious and often is skipped by human operators. It is also prone to error, because many human operators hold scissors differently and a single cut is insufficient to determine any underlying problem with the tool. Other edge sharpness tests have used optics to measure edge sharpness, but it is limited to blades or scalpels. In that method, there is only one scattering angle that is used to measure the cutting edge.

In the case of pitting and corrosion, simple visual inspection is used, but it is difficult for a human operator to keep up with the high throughput demands. The proposed tool should significantly improve detection rates by sending indicators to the workflow teams if there are likely flaws in tools. Finally, with the visual inspection, QR codes are easy to recognize in contrast to infrared imaging.

The disclosed approach uses several of visible cameras that measure the optical scatter from the cutting edge at several angles ranging from approximately 5 degrees (backscatter) to approximately 180 degrees (forward scatter). An algorithm that measures the ratio of forward and backward scattering is then used to quantify changes in the cutting surface.

In the case of sharp tools, a larger backward/forward value is observed and this value decreases after the edge sharpness decreases. Polarization optics is used to enhance visibility of pits and cracks where multiple scattering and depolarization occurs.

One of the main benefits of the instrument is that it can be used to display enhanced, close up images of the tools to operators, which improves a human operator's ability to assess tools in a semi-automated

workflow. Further details of the related systems, apparatus, and methods are described in the Appendices.

### Plenoptic Multi-Modal Surface Imaging Sensor for Surgical Tool Inspection

Conventional optical scattering and sensing techniques can determine many critical properties of cleaned surgical tools. For example, it is well-known that depolarized optical scattering can be used to enhance visibility of voids and cracks when they are illuminated with a polarized light source. Also, protein tags and DNA stains cause biomaterials and microbes to fluoresce at different wavelengths. A problem is that many independent cameras must be placed in proximity to an object under inspection to collect all pieces of useful information. Different view angles create additional problems to align and fuse images, particularly of complex shaped 3D objects. This is a problem if one wants to measure statistical correlations between different observations over the surface of the objects under inspection, at every point on the surface of the device under inspection. Until now, there has been no single sensor that is able to measure many properties at once.

Embodiments in accordance with this invention provide a solution, wherein many kinds of image properties are collected simultaneously with a single objective lens and a single camera.

The invention is inspired by plenoptic imaging but is fundamentally different than plenoptic imaging. Previously, plenoptic imaging systems have been used to measure light fields in standard cameras for the purpose of digital image restoration. Here, plenoptic imaging is applied in a new way. By placing an engineered optical surface with spatially varying optical transmission properties in front of the objective lens of a plenoptic camera, the plenoptic camera can be used to digitally compute a multitude of different optical properties using a single camera and sensor.

Alternative methods would include using multiple sensors. As previously stated, this is less advantageous because of cost, increased difficulty in correlated independent sensor data, and speed. While algorithms are able to align images quickly, small changes in viewing angle, particularly for complex image shapes, make it extremely difficult to accurately overlay different observations. The multi-modal plenoptic technique handles the data overlay automatically and ideally suited for generating rich features for machine learning and automated classification tasks.

In the described systems and methods, the plenoptic camera utilizes a micro-lens array near the sensor to spatially resolve the light rays entering the camera objective aperture. If a spatially engineered surface is placed in close proximity to the entrance aperture to the camera, it is possible then to digitally select a new image property by appropriately sampling pixels from beneath each micro lens. In practice, a specific engineered optical surface is selected that includes crossed polarizers, and multiple fluorescence spectral filters, and at least one unfiltered region of the lens for grayscale imaging.

The proposed method has the main advantage of automatically aligning different imaging modalities, so that multi-modal and hyperdimensional image data can be generated as a function of surface location on a tool being inspected. This data then can be used either as input to machine learned algorithms for detecting tool defects, or the information can be displayed to a human operator to provide enhanced views of tools to promote more accurate human assessments.

In general, while the system and methods described herein have been directed toward surgical instruments, it is contemplated here that the disclosed system and methods can be applied to other scenarios for detecting imperfections or foreign matter on an instrument or instrument part.

Various imaging arrangements are possible. It is contemplated that the imaging system and methods described above can be incorporated into a movable arrangement for scanning instruments placed in its path. It is also possible for the system and apparatus to be stationary and where the instruments are placed on a movable vessel that brings an array of instruments into the infrared imaging path to be inspected. It is also possible to use the infrared system with a mirror or series of mirrors along with an appropriate detector to interrogate different areas of an instrument surface for defects and/or biomass/bioburden.

Referring specifically to FIG. 2, a particular embodiment in accordance with the present invention provides a 360° field of view 150 facilitated by an array of photomultipliers 210, 220, 230 and 240, that have associated filters 211, 2121, 231, 241 and propagated light sources 212, 222, 232, and 242. In an alternative embodiment disclosed in FIG. 1, the array comprises multiple cameras 110, 120, 130, and 140.

The methods described herein can be used in other applications in addition to profiling and inspecting surgical instruments. The inventors have contemplated that the methods described above can be applied to inspecting various other types of instruments for wear and damage.

Other variations and modifications are possible. The description and illustrations are by way of example only. While the description above makes reference to various embodiments, it should be understood that many changes and modifications can be made without departing from the scope of the disclosure and will be apparent to those of ordinary skill in the art. It is intended that the appended claims cover such changes and modifications that fall within the spirit, scope and equivalents of the invention. The invention is not to be restricted to the specific details, representative embodiments, and illustrated except in light as necessitated by the accompanying claims and their equivalents.

What is claimed is:

1. A system for displaying to a user a focus image of a sample and a plurality of other images, said system comprising,
an engineered optical surface with spatially varying optical transmission properties placed in front of an objective lens of a camera.
a system which can display said focus image, and a composite with a thumbnail image of each of said plurality of images, each image capturing a different perspective of the same sample, whereby the system displaying said focus image along with the composite image and a panorama comprising at least two of said plurality of images combined;
a server which receives said composite image, and which provides the focus image and the composite image to the system, and
an input device connected to the system whereby a user can select one of the thumbnails thereby sending a signal to the server indicating which of the plurality of images should be sent to the system as the focus stream.

2. The system of claim 1, wherein the engineered optical surface comprises crossed polarizers.

3. The system of claim 2, wherein the engineered optical surface comprises multiple fluorescence spectral filters.

4. The system of claim 3, wherein the engineered optical surface comprises at least one unfiltered region of the lens for grayscale imaging.

5. The system of claim 1, wherein said server also can access a storage medium to compare the focus image to a reference image for comparative purposes.

6. The system of claim 1, where the plurality of images are captured by the same camera.

7. The system of claim 6, wherein the camera is a plenoptic camera.

8. The system of claim 1, wherein the plurality of images are captured by a plurality of cameras.

9. The system of claim 8, wherein the plurality of cameras is four.

10. A method of sharing selected data from a plurality of cameras to a client machine comprising the steps of:
Capturing image data through a plurality of plenoptic cameras having an engineered optical surface with spatially varying optical transmission properties placed in front of the objective lens of the plenoptic camera;
streaming to a client machine a focus image containing the images from a particular one of said cameras and a second stream, each image in which contains a thumbnail of the images from each of the cameras, each image capturing a different perspective of the same sample, whereby the system displaying said focus image along with the composite image and a panorama comprising at least two of said plurality of images combined,
selecting at said client machine one of said thumbnails and
responding when a thumbnail from a particular camera is selected by making said focus image the image from said selected camera.

11. The method of claim 10, wherein said server also can access a storage medium to compare the focus image to a reference image for comparative purposes.

12. A method for evaluating abnormalities in a surgical instrument, the method comprising:
storing a plurality of images, each image capturing a different perspective of a surgical instrument and being stored as reference images;
receiving a plurality of new images, each image capturing a different perspective of a surgical instrument;
storing this plurality of new images as focus images;
accessing the stored reference and focus images of the same surgical instrument;
displaying the reference images and the focus images; and
compare the differences between the reference images and the focus images for surgical instrument abnormalities.

13. The method of claim 12, wherein the stored reference image and the new focus image data are input to machine learned algorithms for detecting defects.

14. The method of claim 12, wherein the stored reference image and the new focus image are displayed to a human operator to provide enhanced views of the surgical instrument in order to promote more accurate human assessments.

15. The method of claim 12, further comprising the step of introducing peptides that specifically bind serum albumin from multiple species with high affinity in order to enhance the ability for both people and machines to detect bioburden on surgical tools.
